(19) United States
(12) Patent Application Publication
(10) Pub. No.: US 2012/0245965 A1
(43) Pub. Date: Sep. 27, 2012

(54) Endowment with Institutionally Owned Life Insurance

(75) Inventors: Jon Cameron, Dallas, TX (US); Michael Schornstein, Dallas, TX (US)

(73) Assignee: Michael Schornstein, Dallas, TX (US)

(21) Appl. No.: 13/493,436

(22) Filed: Jun. 11, 2012

(51) Int. Cl. G06Q 40/08

(52) U.S. Cl. 705/4

(57) ABSTRACT

A method of converting a series of donations by a donor to an institution so the institution is able to maintain premium payments on an institutionally-owned life insurance policy.

### BACKGROUND

1. Field of Invention

The invention related to the system and method of using institutionally-owned life insurance for the endowment of an institution.

2. Background of the Invention

The present invention is useful and novel method for using life insurance owned by an institution to fund an institution.

It has been a long established practice for individuals to use insurance to fund endowments to institutions. This is traditionally done by individual planning when the donor wishes to be recognized for a larger donation than capital funds would permit. By purchasing a life insurance plan, the endowment is recognized by the institution as the death benefit amount. Thus, a donation of $500,000 could be afforded the same status and recognition as a multi-million dollar endowment. Although the life insurance donation of $500,000 could be spread out over many years of insurance premium payments, the endowment can be recognized as soon as the nomination listing the institution is made by the donor.

For instance, Donor A provides a cash payment of $2,500,000 USD to a university to fund the athletic department. For this donation, the athletics department provides a guest suite for home games and access to department events. Donor B purchases a life insurance policy with total premiums of $500,000 and a death benefit of $5,000,000 USD. The payment schedule includes an initial payment of $50,000 and quarterly payments of $5,900. While Donor B spent less than 3% of Donor A in the first year, and 20% of Donor A overall, Donor B would be afforded greater recognition and additional benefits not offered the “smaller” donation of $2,500,000.

Not including the time value of money, for the same cash used by Donor A, Donor B could endow five (5) institutions at $5,000,000 USD.

For the donor, the general benefits of using life insurance for endowment are clear.

The benefits to the university are less tangible. For instance, the purchase of life insurance for the benefit of institutional endowment is often done without the awareness of the institution itself. As part of periodic financial planning, an advisor may privately suggest to the client the use of life insurance to accomplish a number of goals. For this discussion, the advisor would recommend that instead of setting aside proceeds for the funding of a local church, for example, the donor uses the same funds to purchase life insurance to provide a greater endowment at the time of death. Without notifying the institution, the policyholder nominates the institution as the beneficiary.

This has a number of problems for the institution. Without knowledge of a potential endowment, financial planning is more difficult for the institution. Most importantly, under the Insurance Act of 1938, Section 39, the owner may change the nominee at any time before death. If, in this example, the donor would move to a new community and attend a new church, he would be free to change his nomination with the new church as beneficiary.

In fewer cases, the donor may approach the institution for assistance in planning a death benefit donation. The development officer could suggest the use of life insurance in order to grow the amount of the benefit. At this point, the development officer would recommend an insurance agent or recommend the donor discuss the option with their current insurance agent. Unless they are a registered insurance agent, the development officer is legally prohibited for any further participation including providing any solicitation such a brochure; providing an application; providing a non-binding quote; or receiving, collecting or transmitting a premium; or selling the policy. So the donation advocate loses control of the donation and turns the decision making over to a third party that does not have the institution as the client.

### Endowment Insurance Policy

There are life insurance policies specifically termed as endowment life insurance policies. A customary endowment life insurance policy, or endowment policy, is a contract designed to pay a lump sum at the maturity of the policy or in the advent of illness or death. Endowment policies can be cashed out earlier and the owner of the policy receives a reduced surrender value.

An endowment policy “with profits” has two distinctive characteristics. One, the endowment policy provides a guaranteed payout but the payout can increase on the basis of fund performance of the underlying security. To encourage long term planning, during periods of lower market performance penalties are triggered to prevent withdrawal. These penalties are viewed as positive reinforcement of the primary purpose of the endowment policy: to encourage the incentive to save.

While these policies may be suitable to fund an institution, particularly a with profits endowment policy, that is not their specific function despite the policies' terminology. Typically, these policies are used to insure the holder of debt. They would rarely be used by institutions as institutionally-owned life insurance policies.

These endowment policies are presented as prior art to distinguish from the present invention of using a policy for the purposes of endowing an institution.

### Conclusion

While the benefits of using life insurance for endowment are plentiful for donors, the reliance on life insurance by institutions for endowment is clearly problematic for the purposes of planning and bears unpredictable risk.

FIG. 1 of the drawings will more fully explore traditional models for the use of life insurance to endow institutions.

### Indirect Use of Life Insurance to Fund Institutions

Life insurance can also purchase future rights to receive benefits provided by an institution. For instance, life insurance is typically used by parents or grandparents to plan for a child's tuition requirement to attend an institution of higher education. The Gerber Life Insurance Company's “Gerber College Savings Plan” allows persons with insurable interest to purchase life insurance as soon as a child is born. This type of policy is not intended to provide either the family or institution a benefit at the time of death. Instead, the life insurance is used to provide fixed premium payments, stable growth, and a fixed payout.

While an educational institution is intended to benefit from the policy in the form of tuition, this type of funding is indirect because the benefitting institution is not designated, whether through permanent conveyance or nomination, at any point in the policy term. These tuition savings life insurance policies also do not have penalties in the event the policy is used for non-educational purposes. Additionally, many of these policies provide incentives to not use the policy for tuition and instead encourage the student to carry the policy past typical undergraduate ages. This can be useful if the policy's value is significantly higher when college loans begin payment terms.

Funding with Institution-Owned Life Insurance

Found within the patent art are several patents which specifically address the use of life insurance to fund an institution. “Method for funding an organization,” U.S. Pat. No. 7,451,104 claims the invention of the institution buying life insurance policies on a person of insurable interest associated with the primary institution. The patent claims the use of asset-backed securities to then fund the life insurance policies which are then placed at a secondary entity.

The same inventors filed “System for Funding an Organization,” United States Patent Application 20080294566, now abandoned, on the use of life insurance for funding a bankrupt institution. This application also claims the use of remote secondary entity with the same insurable interest as the bankrupt primary institution. The life insurance policy is self-funding and produces “lumpy cash flows when paid to said beneficiary.” These lumpy cash flows are then swapped by a provider to produce smooth, guaranteed cash flows.

Both of these prior art show the well-known process of funding an institution using life insurance by the institution purchasing life using the institution's funds, typically in the form of asset-backed securities.

### Insurable Interest

The central element to any life insurance product is the consideration of insurable interest. Insurable interest is defined as a person or entity that would suffer a financial loss, or other kind of loss such as an emotional loss, in the event there is loss or damage to the insured. In the case of life insurance, the owner of the policy must have an insurable interest in the insured individual.

Legal guidelines have been established which generally limit this to certain family member combinations such as spouses, parent/children, brother/sisters and grandparents/grandchildren. A company or public institution may also have an insurable interest on key executives and employees with special knowledge. A creditor would have an insurable interest on the life of the debtor.

There are two exceptions to the laws surrounding insurable interest. They are considered exceptions because the relations between the parties are created by contract or by informal relationship.

The first exception is called viatical settlement which is the sale of a policy owner's existing life insurance policy to a third party. This is usually done by individuals who are terminally ill as defined by various objective tests.

The second insurable interest exception is related to charitable donations. There is a constant flux of federal laws, state laws and taxation rules which variously allow charities to have an insurable interest in individuals, such as donors to the charities. Consider the example of a charity that is reliant on older donors and there is no guarantee that their heirs will continue to give to the same organizations. The charity would seemingly have a clear insurable interest in its donors in order to maintain the operations of the charity. Yet the use of life insurance by charities has viable legislative risk due to the very flux of laws on which they maintain their insurable interest. Even assuming that future legislation would grandfather current policy, there still remains significant risk of civil procedure to challenge the validity of the charity's insurable risk. Civil litigation costs could outweigh the benefits of using life insurance to continue charitable donations after death. Adding even more risk is that taxation rules, which rarely provide the benefit of grandfathering, could significantly alter the future financial return on the use of life insurance plans with non-traditional insurable interest claims.

### Stranger-Owned Life Insurance

Stranger-owned life insurance (STOLI) is the process of an investor soliciting to purchase the insurable interest of individuals. The central issue of STOLI policies is state laws surrounding insurable interest. These laws universally focus on a two-part test. The first is that the insured's death would cost the owner of the policy. This first test is fairly easy to overcome so the law focuses on whether the owner of the policy is gaining benefit from the insured continuing to live. This second test cannot be easily manufactured.

Stranger-owned policies are schemes that overcome the need for the owner of the policy to receive a continuity of life benefit. This is done by either legally borrowing such benefit or exploiting loopholes within insurance laws.

Characteristics of STOLI policies include:
1. Investor solicits the life insurance.
2. The investor does not have a relationship with the person intended to be the insured.
3. The investor uses a 3^{rd} party, such as a charity, to borrow the charity's insurable interest.
4. The investor promises a portion of the death benefit to the charity.
5. The investor makes an initial donation to the charity.
6. The investor offers compensation to the insured including intangible benefits.
7. One agent writes a large number of policies simultaneously.
8. The death benefit is conveyed to the investor.
9. Most importantly, the insured has no intention of using their own resources to fund the premiums. The investor pays for the premiums.

STOLI policies are much lamented by the insurance industry and insurers make concerted effort to punish the insurance agents even if the law permits these policies. The reason is that insurance companies count on insurers to lose interest in the need for the policy. The cancellation of the policy causes the previous premium payments to become shear profit for the insurer. This profit is inherent in the pricing of life insurance so they insurer remains profitable. STOLI policies tend to have very little cancellations and therefore reduce the insurer's return. If STOLI plans are used to fund institutions, eventually other life insurance buyers must start paying for those policies through premium increases.

Investors stand on contract law that a policy contract was issued and those premiums were paid. Therefore, it is an enforceable contract.

### Description of First Key Element of Prior Art

Insurable interest not solicited by the institution. While life insurance is both a useful and attractive option for donors to endow an institution, the institution is unable to legally solicit the use the insurance for the institution's benefit. The reason is state and federal laws define the role of the agent in a way that prohibits anyone but an insurance agent to solicit insurance. This includes conducting tasks of direct response solicitation such as emails, telephonic communication, and printed materials. Regardless of whether the act is done at the request of or by the employment of an insurer, broker, or other person, a person is the legal agent of the insurer for which the act is done. An agent is a licensed individual, not an organization or entity, even if the entity is composed entirely of insurance agents.

As a result, institutions are unable to strategically plan to sell life insurance as a means to fund their endowment requirements unless they specifically train institutional personnel as legal agents and provide an internal “Chinese wall” so that all individuals handling such solicitations and policies are agents.

### Description of Second Key Element of Prior Art

Premium payments are maintained by the donor. Under existing prior art, the donor would obtain a life insurance policy for themselves and then nominate the institution as a beneficiary. The donor directly pays the premium payment to the insurer.

While the policy is donated to the institution, the premium payments are not.

Notably, life insurance companies calculate premiums based on the expectation that a large percent of policies will never pay because the premium payments are abandoned by the insured.

These cancellation rates introduce problems for institution with donations in the form of life insurance. First, the institution is unable to monitor the cancellation of donor policies because they possess no rights to monitor the status of the charitable donations in the advent of a nomination. Therefore, the institution, as the beneficiary but not the owner, is unable to access the risk or opportunity to make the payments on behalf of the insured. For instance if a policy is near the sum assured amount, it may be in the institution's best interests to maintain the premium payments on the policy.

The institution is also unable to adjust endowment requirements based on cancelled policies. Once the policy is cancelled, it cannot be reinstated. This can essentially leave the institution blind for decades as promised endowments go unmet. The inability for the institution to control risk associated with existing life insurance endowments can make these policies unattractive contribution instruments.

### Description of Third Key Elements of Prior Art

Nomination as a conveyance. Nomination is the right of the policyholder to appoint a person or entity to receive the policy payout at the time of death. The person or entity is referred to as the beneficiary. Either during the policy application process, or at any time during the life of the policy, the policyholder can nominate the beneficiary. The policyholder can change the designated nominee as often as they wish and at any point in time. This can be simply, and preferably, be done by endorsing the back of the policy documents or placing the nomination on a piece of paper attached to the policy. The nomination need only state the nominee's full name, relationship to the policyholder and age.

So this beneficiary role creates additional risk for the institution in the ease of its re-conveyance.

### Description of Fourth Key Element of Prior Art

Leveraged securities to pay premiums. In life insurance products from the prior art, the institution either self-funds the premium payment or leverages the policy to create a self-funding mechanism.

Therefore the cost of the policy borne by the institution would be reduced from total return. This increases both the risk while simultaneously reducing the total return.

### SUMMARY OF THE INVENTION

An invention, which meets the needs stated above, is a system and method which allows a donor to leverage a smaller donation into a larger endowment to fund an institution. The institution's third-party insurance representatives solicit the donor to purchase life insurance with the ownership designation listed as the institution. The donor makes a donation to the institution which then uses the donation to fund the life insurance policy. The permanent ownership designation in the application transfers all rights and liabilities of the policy to the institution.

### OBJECTS AND ADVANTAGES

Accordingly, besides the objects and advantages of the Endowment with Institutionally Owned Life Insurance, further objects and advantages of the present invention are:
a) Insurable interest in the policy is created because the applicant is insuring their own life.
b) To eliminate the need for institutional self-funding, the donor makes donations to the institution for the at least the amount of the premium.
c) The policy is permanently owned by the institution to eliminate the risk the insured will nominate another beneficiary at a later time. This method of permanent ownership gives the institution all commercial and legal rights.
d) The institution maintains the policy by directing the charitable donation into life insurance premiums. This allows the institution to accurately determine the true value of promised endowments.
e) If the donations cease on a particular policy, the institutional is able to do a risk analysis of self-funding the policy based on the cash value of the policy.
f) Since the policy is funded by donations from the insured, the policy avoids classification as a stranger-owned life insurance policy.
g) Since the policy is funded by donations from the insured, it avoids insurable interest conflicts.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures;

FIG. 1.—Flow chart depicting the prior art actions of the life insurance agent from the initial solicitation to the commission payment.

FIG. 2.—Flow chart depicting the combined actions, in the present invention, of the combined role of the institution and life insurance agent.

FIG. 3.—Flow chart demonstrating an example of the present invention's data and payment transactions for endowing a institution with a life insurance policy.

### REFERENCE NUMERALS IN DRAWINGS

10 Donor, Alumni, Insured
20 Institution, University, Organization, Applicant
30 Insurance Agent, Agent
40 Insurance Provider, Insurer
50 Application Processor, Processor
110 Solicitation
120 Short form
130 Quote
140 Application, Insurer's application
150 Transfer of interest, Convey, Conveyance
155 Policy Owner, Owner
160 Premium Offer, Offer, Denial
170 Insurance Contract
180 Insurance policy, Life insurance policy
190 Pledge Agreement
200 Premium Payment, Payment, Initial Payment
210 Donation
220 Commission
230 Benefit Payment

### DETAILED DESCRIPTION OF THE DRAWINGS

Referring to the drawings, in which like numerals represent like elements,

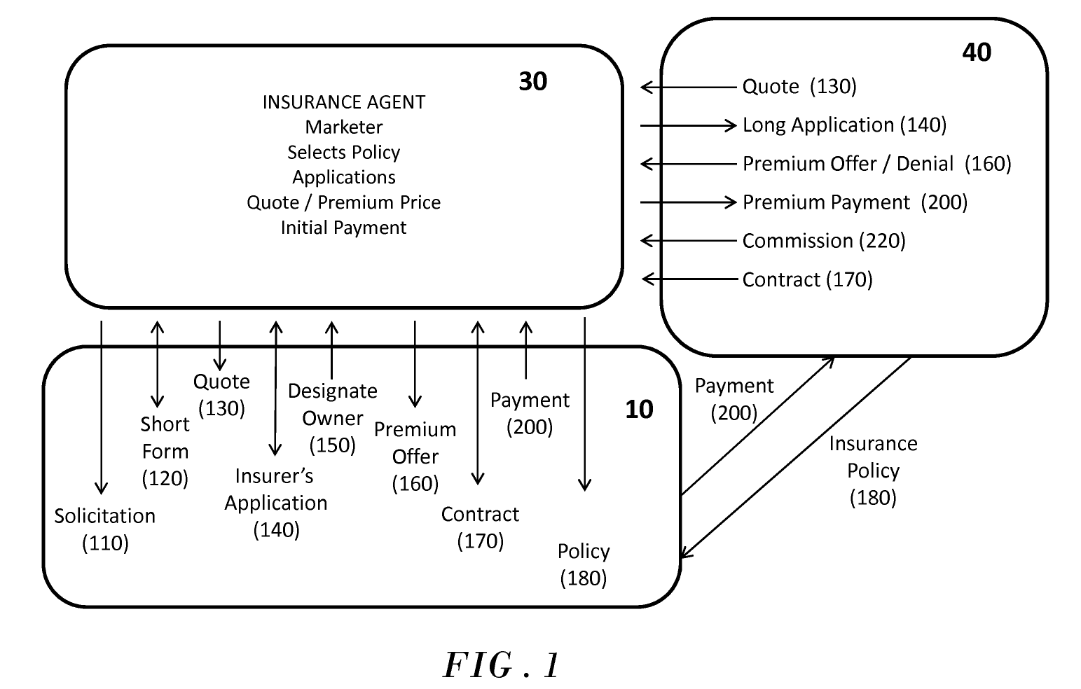

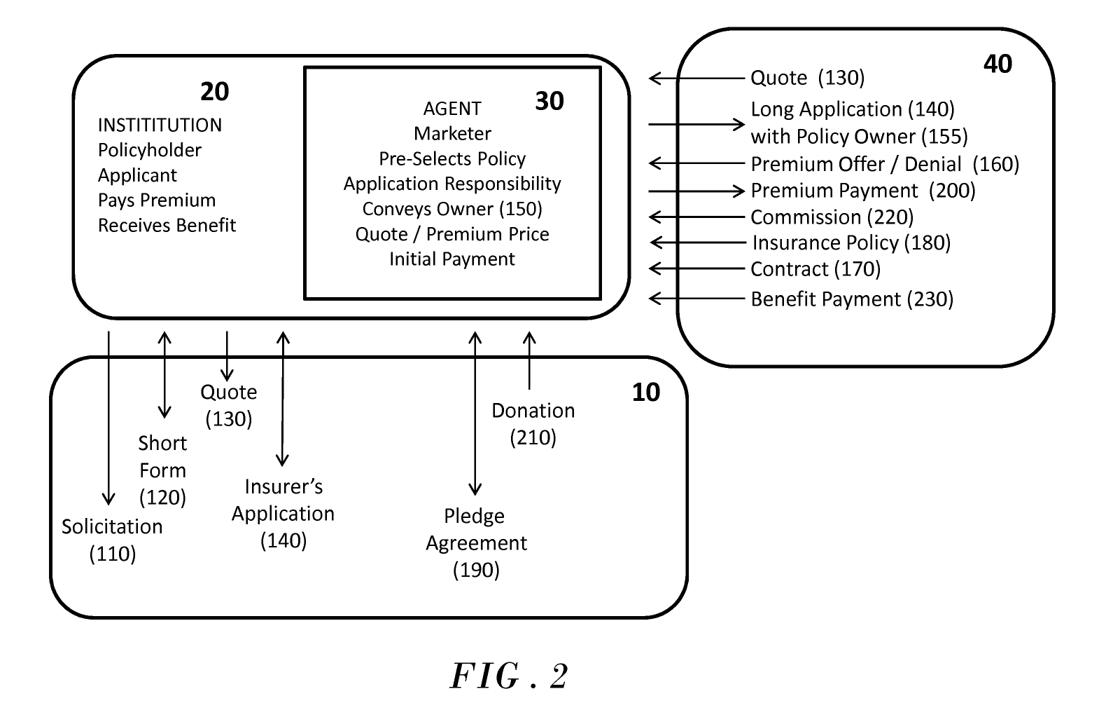

### FIGS. 1 and 2—Party Roles

Turning to FIG. 1, the prior art logic flow chart depicts an insurance agent's 30 current responsibilities in soliciting 110 and processing an insurance policy 180 for life insurance.

Moving left to right and top to bottom in sequential order of execution, the first step is the agent 30 provides a solicitation 110 on behalf of the institution 20. The solicitation 110 will use the brand of the institution 20 and will involve an electronic communication such as email or an announcement at a designated website. This communication can be made by either the insurance agent 30 on behalf of the institution 20 or by the institution 20 identify the agent 30 as the legal representative.

This begins the process of the agent 30 representing the institution 20 while simultaneously assuring the institution 20 does not violate laws that require the activities in this chart to be completed by a licensed insurance agent 30.

Typically, after receiving the solicitation 110, the donor 10 can receive a quote 130 by utilizing a computer-implemented interactive form. This allows the agent 30 to be able to provide a quote 130 or compare quotes 130 from various insurance providers 40. Alternately, the agent 30 can contact the donor 10 and interview the donor 10 to determine the initial quote 130. The quote 130 is provided by the insurer(s) 40, using illustrations based on criteria such as sex and age, and may be stored by the agent 30 for later display. The quote 130 may also be instantaneous provided by the insurer 40 and conveyed 150 to the donor 10 through the agent's 30 online website. The agent 20 is responsible for the function of delivering the quote 130 to the donor 10.

Assuming the quote meets the approval of the applicant 10, the donor 10 notifies the insurer 40 of an interest to continue with the application 140 process. Electronically, this notification by the donor 10 can be executed online by accepting the initial terms of the policy 180.

In subsequent functions, the donor 10 completes the application 140. There are multiple ways this can be done. The most common method is the insurance agent 30 interviews the donor 10 and completes the complicated document 140. In this case, the insurer's application 140 can either be a manual form or completed by accessing the insurance agent's computer-implemented interactive system.

The second method to successfully complete the insurer's application 140 is the insurer 40 hires another party 50 to assist the donor 10. This application processor 50 will then interview the donor 10 and enter the information using automated forms. The processor 50 may also order medical records or have medical test conducted.

The third method is the donor 10 accesses an online system which collects the information keyed by the donor 10 themselves. This generally still requires the intervention of the insurance agent 30 or the processor 50.

At the time of the application 140, the donor 10 may designate the policy owner 155 of the life insurance policy 180. This is done a number of ways but typically the insurer's application 140 will ask for the name of the policy owner 155. For instance, if an alumni 10 wants to donate his policy 180 to a university 20, he would simply designate the policy owner 155 in the application 140 as the university 20 and provide the relevant details for contacting the institution 20. The ownership 155 can be very specific. In the present example, the alumni 10 can designate they wish for the proceeds to go a specific department, organization 20, or project within the institution 20.

It is also possible to later convey 150 the policy 180 to the institution 20 using a variety of means such as sale, permanent conveyance 150, or nominating a beneficiary. Each of these conveyances 150 relay different rights to the institution 20 which may be either permanent or temporary. The institution 20 may be unaware of the conveyance 150 until the death benefits become due.

Once the application 140 is completed, the insurer 40 makes a decision on whether or not to issue a life insurance policy 180. The insurer communicates the decision with a premium offer or denial 160 to the insurance agent 30 which has the responsibility to relay the decision to the institution 20. The premium offer 160 will include a specific premium payment(s) 200 in order for the insurance policy 180 to be maintained.

The offer 160 will also include an insurance contract 170 for the institution 20 to sign and return to the agent 30. At the same time, the initial payment 200 would be made by the institution 10.

The agent 30 then forwards the insurance contract 170 and initial payment 200 to the insurer 40.

The insurer 40 subsequently pays a commission 220 to the insurance agent 30.

Once processed, the insurer 40 will issue the insurance policy 180 to the agent 30 or directly to the institution 20. At this point, the role of the agent 30 has ended and future payments 200 are made by the institution 20 directly to the insurer 40.

Turning now to FIG. 2 of the present invention, the institution 20 and the agent 30 combine roles so that the institution 20 is able to legally solicit life insurance policies 180 to donors 10. For all intents and purposes, the institution 20 represents to the donor 10 that the solicitations 110 and communications are made between the donor 10 and institution 20. This limits the insurance agent's 30 role as the silent, back-room operator of the institution 20 but maintains all legal roles of an agent 30.

So FIG. 1 and FIG. 2 are similar except the combined entities in the present invention of FIG. 2 take on the role of both the agent 30 and the institution 20. Combined, the entities still provide a solicitation 110; provide a short form 120 for the purposes of quoting 130; supply and assist in the processing of the insurer's portion of the application 140; provide a designated owner 155; process the contract 170 provided by the insurer 40; and delivery of the final policy 180.

The two figures vary significantly in the relationship that is established between the institution 20 and the donor 10. While that relationship would be nonexistent or terminate after the policy 180 issued in the prior art, the present invention assures a long-term relationship between the donor 10 and the institution 20 because the institution 20 controls the entire application 140 process.

Simultaneously, with the institution's 20 elevated involvement, the number of processes in which the donor 10 participates decrease.

Significantly in the present invention, the donor 10 has a much more limited role in the application process. The reason for this limited time commitment is the institution 20 becomes the applicant 20. Since the primary burden of completing the bulk of a life insurance application 140 is the responsibility of the applicant 20, the institution 20 absorbs the responsibilities. The benefit is a reduced time commitment risk for the donor 10. The insurance agent 30 collects a brief amount of data on the insured individual 10 and the remainder of the application process is handled by the insurance agent 10 and the institution 20. In a typical application of forty (40) pages, the donor may be obligated to only complete three (3) full pages.

However, this does not suggest the institution 20 absorbs a larger time commitment to offset the reduced labor by the donor 10. By automating and standardizing the process, hundreds of forms can be filled simultaneously and accurately. With the institution 20 as the primary applicant 20, the entire process from the donor 10, to the insurance agent 20, to the institution 30, and even to the application processor 40 is streamlined with a significant increase in quality assurance.

In order for the legal applicant 20 to be switched from a donor 10 to the institution 20, the application would designate the owner 155 of the policy as the institution 20. In a preferred embodiment, this would be electronically filled by the institution 20 or agent 30 at the same time the remainder of the application 140 is electronically prepared. As the owner 155 of the insurance policy 180, the institution 20 has total control of both the application 140 and the issued policy 180 for the life of the policy 180. There is no risk the policy 180 can be later granted to another individual or institution 20 as there is with other conveyances 150 such as nomination.

Along with the insurance contract 170, the institution 20 receives the premium offer 160 from the insurer 40. Instead of relaying the premium offer 160 to the donor 10 by the agent 30, the premium offer 160 is sent to the institution 20. The institution 20 then prepares a communication to the donor describing the terms of a pledge agreement 190. The pledge agreement 190 will provide a minimal amount of pledge, and structure of that pledge, amount needed to fund the intended endowment. It should be noted the premium offer 160 and pledge agreement 190 will likely differ in amount from the original quote 130 made after the short form 120. The premium offer 160 and the pledge agreement 190 may also be different, but the pledge agreement 190 will be equal to or greater than the premium offer 160.

If the donor 10 agrees to the terms of the pledge agreement 190, the insurance contract 170 is approved by the institution 20 and returned with the first premium payment 200.

However, if the insurer 30 denies converage 160, the institution 20 can still submit a pledge 190 offer instead of terminating the relationship with the donor 10.

Insurable interest is established because the funding of the premium payment 200 is provided by the insured 10 in the form of a donation 210 from the donor 10 to the institution 30 for at least the amount of the premium payment 200. For the same reason, STOLI policy concerns from the insurer 30 are overcome because a key hurdle in most application's 140 questionnaire is the source of funds for the premium payment 200.

Comparing FIG. 1 and the present invention in FIG. 2, the initial premium payment 200 can only be made by the institution 20 because they are now the applicant 20. The subsequent premium payment 200 to the insurer 40 by the donor 10 would also be eliminated in the present invention. In the prior art FIG. 1, the donor 10 makes the remaining premium payments 200 directly to the insurer 40, bypassing the agent 30. In FIG. 2 of the present invention, the donor 10 makes no insurance payments 200 to the insurer 40. Instead, the donor 10 makes a donation 210 to the institution 20. Varying from the prior art, only the institution 20 can make subsequent premium payments 200. In the preferred embodiment this would be done by converting the donations 210 from the insured 10 into premium payments 200. However, if the donor 10 lapses on the donation 210, the institution 20 may later determine the value of the policy 180 exceeds the remaining premium payment(s) 200 and the institution 20 can make those payment(s) 200 absent from the continued donation(s) 210 of the insured 10.

In FIG. 2, as a possible embodiment, the initial payment 200 can be made by the institution 20 prior to or after the initial donation 210 from the donor 10. Once the initial payment 200 is made, the insurance policy 180 is forwarded to the institution 20 instead of the donor 10.

In FIG. 2, the institution 20 also receives the benefit payment 230 which may be managed and directed by the agent 30 or by the institution 20 itself.

The present invention allows the institution 20 to become central to the advertising, solicitation 110, processing, and management of a system which they previously were unable to participate or evaluate.

Institution 20, as used herein, comprises businesses, organizations, for profits, nonprofits, departments within an institution, projects, charities, foundations, trusts, educational institutions, religious institutions and government entities.

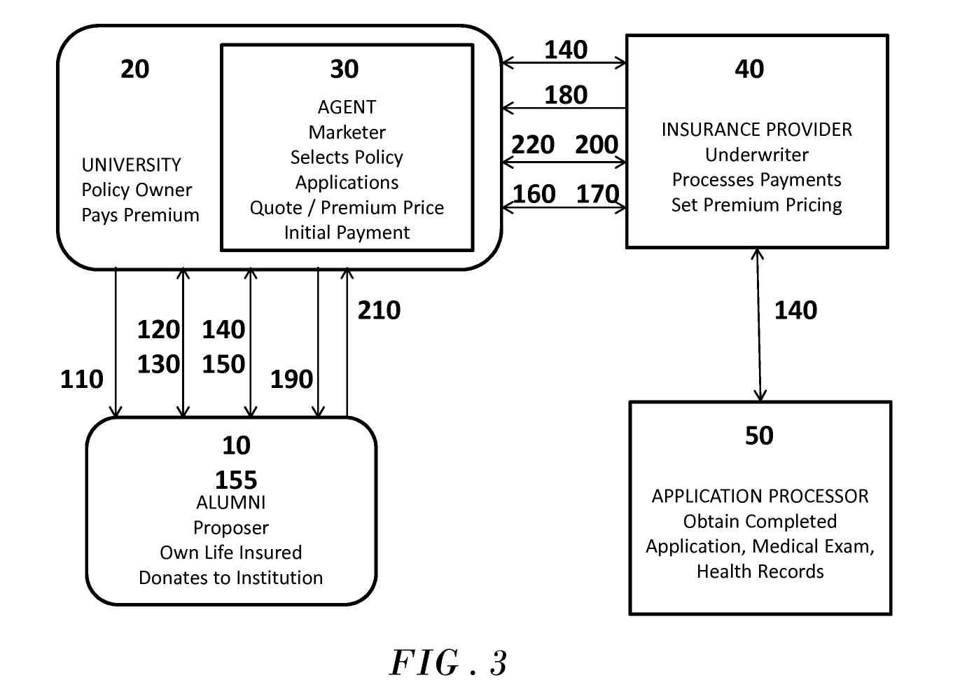

### FIG. 3

Finally, turning to FIG. 3 is an example of the use of the current invention for a university 20 to provide endowment opportunities for alumni 10. This university 20 wants to offer endowment opportunities to middle and low-upper income graduates. This target is not typically a target of educational institutions 20 because of the smaller size of the donations 210. This makes the target unprofitable for the university's 20 limited staff. In addition, the use of life insurance 180 for this target is problematic for insurance agents 30 because smaller premium policies are as time-consuming for an insurance agent 30 as a much larger policy 180.

In order to overcome these challenges, the university 20 enters into a relationship with an insurance agent 30 to manage and automate the use of life insurance policies 180 to grow endowment. The agent 30 handles all the tasks legally required to be under an agent's 30 control. The agent's 30 role begins at the first solicitation 110 to the donor 10 and continues until the transmittal of the premium offer 160 and insurance contract 170 to the institution 20.

The university 20 and agent 30 preselect a life insurance policy 180 which meets the requirements of the university 20 and is priced to be accessible to the target alumni 10.

The agent 30 transmits a solicitation 110 email with the university's 20 branding to the alumni 10 using the university's 20 secure email list. This solicitation 110 may be issued from either a university 20 owned or agent 30 owned computer system. If it is desirable to use the university 20 system, the transmission of the solicitation 110 is overseen by the agent 30 as required by local laws.

Once received, the alumni 10 has the option to click a link and input basic data to receive an instant quote 130 previously supplied to the insurance agent by the insurance provider 40. This form can ask for a very limited amount of information such as age or birth date; and gender. In an embodiment of the present invention, the quote 130 could be provided in the solicitation 110 based on the university's 20 profile of the alumni 10.

The email may also provide a link to online content about the endowment opportunity. This allows the information to be organized in a nonlinear format required by email presentations. The online content can be the same content destination as the short form 120 and quote 130 engine.

After reviewing the instant quote 130, the alumni 10 can select to continue the process for obtaining life insurance 180 to endow the university 20. This will initiate the insurer's application 140 by sending an electronic notice to any combination of the university 20, insurance agent 30 and insurance provider 40. A short form 120 will ask for more detailed information such as the name of the insured 10, amount of donation 210, pay period, and institutional owner 20. Typically, the insurance provider 40 uses an outside company, or application processor 50, to automate the completion of the insurer's application 140 processes. Using computer-implemented interactive systems, the application processor 50 will work with the institution 20 the agent 30 and alumni 10 to complete the application 140 requirements of the insurer 40. This may include obtaining medical records from the alumni's 10 physician and ordering additional medical tests.

The application is preload with the university 20 as the policy owner 155 by placing the institution's 20 contact information in the owner 155 designation section of the application 140.

Now that the institution 20 is the policy owner 155, and thus the applicant 20 in the present invention, the bulk of the application 140 responsibilities fall on the institution 20. This relieves the donors 10 from the onerous task of completing life insurance applications 140 which can be in excess of forty (40) pages in length. Since the institution 20 is using a standardized and pre-selected insurance policy 180, the institution 20 is able to benefit from the automating the lengthy and now standardized portions of the application 140.

Once the application 140 is completed, it is forwarded to the insurance provider 40 for a decision on making an offer or denial 160.

If an offer 160 is made by the insurer 40 to the institution 20, the institution 20 then notifies the alumni 10 of the insurance premium 160 offered the university 20. This notification is made by the university 20 to the donor 20 with the use of a pledge agreement 190. The pledge agreement 190 specifies the minimum donation 210 required to both put the policy 180 into force and maintain the policy 180.

Therefore, the alumni 10 never receives a premium offer 160. The pledge agreement is signed by the donor 10 and the university 20 notifies the insurer 30 that the university 20 accepts the premium offer 160. There is no communication between the insurer 40 and donor 10.

The alumni 10 makes a donation 210 to the university 20 for at least the value of the initial premium payment 200. The payment 200 may also be for other periods, such as quarterly, or even for the entire amount of the premiums 200. At no point does the alumni 10 make a premium payment 200 to the insurance provider 40.

The university 20 or agent 30 processes the donation 210 from the alumni 10 and converts the donation 210 into the premium payment 200.

Additionally, the insurance policy 180 is not transmitted to the alumni 10 as in the prior art. With the university previously designated as the owner 155 of the policy 180, the life insurance policy 180 is transmitted to the university 20 instead of the alumni 10.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

### ADVANTAGES

From the description above, a number of advantages become evident for the “Endowment with Institutionally Owned Life Insurance.” The present invention provides all new benefits for participating parties such as the institution, the donor, and the insurance agent, including:
a) By automating the process using computers, the institution is able to solicit donors to purchase life insurance using remote insurance agents.
b) By automating the process using computers, insurance agents are able to sell and process lower-value life insurance policies that were previously unprofitable to sell.
c) By automating the application process, the agent can preload the ownership designation fields to assure the institution's ownership of the policy.
d) By automating the scheduling of the donor payment process, the insurance premium can be funded over time. This establishes a long-term relationship between the donor and institution.
e) By using systems to convert the donation to an insurance payment, the institution can manage risk and accurately track a large portfolio of life insurance assets.
f) Because the policy applicant is the institution, and the policy is preselected, the bulk of the application can be preloaded using an electronic system. This reduces the stress and reluctance of the donor to participate.
g) By using the donation conversion computer system, the policy avoids classification as a stranger-owned life insurance policy.
h) Automation significantly expedites the application process.

What is claimed is:

1. A method for using life insurance for endowing an institution, the method comprising:
a. An institution solicits a donor to fund a at least one predetermined life insurance policy;
b. Said institution purchases said life insurance policy from an insurer;
c. Said donor conveys transferrable interest of the life insurance policy to the institution;
d. Said donor makes a donation to said institution at least in the amount of the premium payment;
e. Said institution uses said donation amount to make said premium payment.

2. A method of claim 1, wherein said transferrable interest comprises an ownership designation.

3. A method of claim 1, wherein said transferrable interest comprises an assignment.

4. A method of claim 1, wherein said transferrable interest comprises an irrevocable beneficiary.

5. A method of claim 1, wherein said life insurance policy comprises a term policy.

6. A method of claim 1, wherein said life insurance policy comprises a whole life policy.

7. A method of claim 1, wherein said life insurance policy comprises a universal life policy.

8. A system for automatically soliciting and processing life insurance applications, said system comprising: a communications system, coupled to a network linked to the internet, configured to transmit an electronic communication from the institution to the donor, to fund life insurance for donation to said institution, to provide an estimate of the donation to support donor's desired endowment amount; a processing module comprising a processor, operably coupled to a network via a communications link to an insurer, configured to communicate the donor's applications, to designate the owner as the institution, to transmit a premium offer, to transmit an endowment contract to the donor, to transmit said endowment contract from the donor, to accept a donation from the donor, to transmit an insurance premium payment to the insurer from the institution; wherein the institution may purchase said life insurance using the donor's said donation.
